(19) United States
(12) Patent Application Publication
(10) Pub. No.: US 2025/0141474 A1
(43) Pub. Date: May 1, 2025

(54) TRANSMISSION APPARATUS

(71) Applicant: NIPPON TELEGRAPH AND TELEPHONE CORPORATION, Tokyo (JP)

(72) Inventors: Ken HIRAGA, Tokyo (JP); Doohwan LEE, Tokyo (JP); Hiroyuki SHIBA, Tokyo (JP); Jun MASHINO, Tokyo (JP); Hirofumi SASAKI, Tokyo (JP); Honoka ITO, Tokyo (JP); Yasunori YAGI, Tokyo (JP); Tomoya KAGEYAMA, Tokyo (JP)

(21) Appl. No.: 18/835,459

(22) PCT Filed: Feb. 22, 2022
(86) PCT No.: PCT/JP2022/007268

§ 371 Date: Aug. 2, 2024

(51) Int. Cl. H04B 1/00; H04B 7/06

(52) U.S. Cl. CPC H04B 1/0007; H04B 1/0096; H04B 7/0617

(57) ABSTRACT

A transmission device includes: a first frequency converter configured to convert a frequency of a baseband signal into an intermediate frequency according to a desired OAM mode; a delay line configured to generate a delay in a signal of the intermediate frequency; and a second frequency converter configured to convert the signal of the intermediate frequency in which the delay is generated into a constant radio frequency.

### TECHNICAL FIELD

The present invention relates to a technology for spatially multiplexing and transmitting radio signals using an orbital angular momentum (OAM) of electromagnetic waves.

### BACKGROUND ART

In recent years, in order to improve a transmission capacity, a spatial multiplexing transmission technology for a radio signal using OAM has been studied (for example, Non Patent Literature 1). In electromagnetic waves having OAM, an equiphase surface is spirally distributed in a propagation direction around a propagation axis. Since electromagnetic waves having different OAM modes and propagating in the same direction have spatial phase distributions orthogonal to each other in a rotation axis direction, it is possible to multiplex and transmit signals by separating signals in respective OAM modes modulated with different signal sequences in a reception device.

In a wireless communication system using the OAM multiplexing technology, spatial multiplexing transmission of different signal sequences can be achieved by generating, combining, and transmitting a plurality of OAM modes using a uniform circular array (hereinafter referred to as a UCA) in which a plurality of antenna elements are circularly arranged at equal intervals (for example, Non Patent Literature 2). For example, a Butler circuit (Butler matrix circuit) is used for signal generation and signal separation in a plurality of OAM modes.

In addition, a technology for switching an OAM mode has been developed. For example, Patent Literature 1 discloses a technology for switching between a plurality of OAM modes using discrete Fourier transform. Patent Literature 2 discloses a technology for switching an OAM mode caused by radiation from a pseudo traveling wave resonator using a metamaterial structure by changing a magnetic field to be applied.

### CITATION LIST

### Patent Literature

### Patent Literature 1: JP 2017-515337 T

### Patent Literature 2: JP 2019-153978 A

### Non Patent Literature

Non Patent Literature 1: J. Wang et al., “Terabit free-space data transmission employing orbital angular momentum multiplexing”, Nature Photonics, Vol. 6, pp. 488-496, July 2012.

Non Patent Literature 2: Y. Yan et al., “High-capacity millimeter-wave communications with orbital angular momentum multiplexing”, Nature Commun., vol. 5, p. 4876 September 2014.

### SUMMARY OF INVENTION

### Technical Problem

As described above, a transmission device using a UCA and a Butler circuit enables large-capacity communication, but in the future, it is desired to cope with miniaturization, power saving, or the like. However, in the conventional wireless transmission technology, there is a problem that it is difficult to implement various OAM modes such as switching of an OAM mode and use of a fractional OAM mode.

An object of the disclosed technology is to implement various OAM modes.

### Solution to Problem

The disclosed technology is a transmission device including: a first frequency converter configured to convert a frequency of a baseband signal into an intermediate frequency according to a desired OAM mode; a delay line configured to generate a delay in a signal of the intermediate frequency; and a second frequency converter configured to convert the signal of the intermediate frequency in which the delay is generated into a constant radio frequency.

### Advantageous Effects of Invention

Various OAM modes can be implemented.

### BRIEF DESCRIPTION OF DRAWINGS

FIG. 1 is a diagram illustrating a phase setting example of a UCA for generating a signal in an OAM mode.

FIG. 2 is a diagram illustrating an example of a phase distribution and a signal intensity distribution of an OAM multiplex signal.

FIG. 3 is a configuration diagram illustrating a communication system according to an embodiment of the present invention.

FIG. 4 is a diagram illustrating an example of a hardware configuration of a transmission device according to an embodiment of the present invention.

### DESCRIPTION OF EMBODIMENTS

An embodiment (present embodiment) of the present invention will be described below with reference to the drawings. The embodiment to be described below is merely an example, and embodiments to which the present invention is applied are not limited to the embodiment to be described below.

### Conventional Problems

Conventionally, a configuration using an OAM mode variable array antenna for the purpose of OAM mode modulation or switching between OAM modes for use in a wireless communication device that performs wireless transmission utilizing an OAM mode using a circular array antenna is known. However, in a case where the OAM mode variable array antenna is used, it is necessary to control a phase shifter included in each antenna element. Furthermore, when a large number of phase shifters are used, there is a likelihood that a variation in the phase shift variation amount occurs.

There is also a method of switching a signal input terminal using a matrix circuit, but it is not possible to continuously change the OAM mode, including the fractional mode.

### Overview of Present Embodiment

A transmission device according to the present embodiment is provided with a delay line on each branch with a variable intermediate frequency (IF) while keeping a radio frequency (RF) constant. In addition, a local oscillation frequency of a first frequency converter from baseband to IF and a local oscillation frequency of a second frequency converter from IF to RF are made variable, and the RF frequency is made constant while the IF frequency can be changed. This changes the phase shift amount in the circuit that generates the fixed time delay by changing the IF frequency according to the OAM mode that is desired to be used.

### Basic Operation Example

A basic setting/operation example related to a UCA used in each device in the present embodiment will be described.

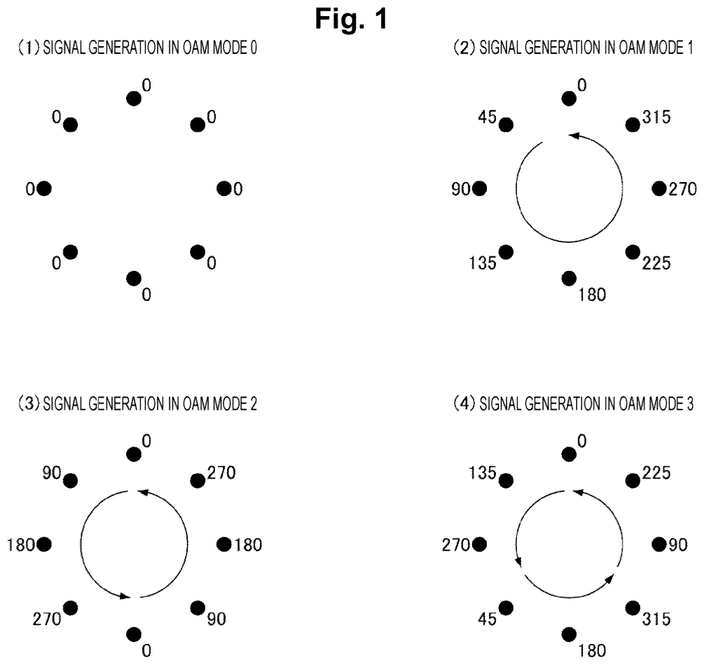

FIG. 1 is a diagram illustrating a phase setting example of a UCA for generating a signal in an OAM mode. The UCA illustrated in FIG. 1 is a UCA including eight antenna elements.

In FIG. 1, signals in the OAM modes 0, 1, 2, 3, . . . on a transmitting side are generated by phase differences of signals supplied to the antenna elements (indicated by *) of the UCA. That is, a signal in an OAM mode n is generated by setting a phase of the signal to be supplied to each antenna element such that the phase rotates by n (n×360 degrees). For example, in a case where the UCA includes m=8 antenna elements as illustrated in FIG. 1, and a signal in the OAM mode n=2 is generated, as illustrated in FIG. 1 (3), a phase difference (0 degrees, 90 degrees, 180 degrees, 270 degrees, 0 degrees, 90 degrees, 180 degrees, 270 degrees) of 360 n/m=90 degrees is set for each antenna element counterclockwise such that the phase rotates twice.

A signal of which a phase rotation direction is reversed to the signal in the OAM mode n is referred to as an OAM mode-n. For example, a phase rotation direction of a signal in a positive OAM mode is set to the counterclockwise direction, and a phase rotation direction of a signal in a negative OAM mode is set to the clockwise direction.

Wireless communication using spatial multiplexing can be performed by generating different signal sequences as signals in different OAM modes and simultaneously transmitting the generated signals. The transmitting side may generate and combine signals to be transmitted in each OAM mode in advance, and transmit a combined signal of each OAM mode by a single UCA, or may transmit a signal of each OAM mode by a different UCA for each OAM mode by using a plurality of UCAs.

In order to separate an OAM multiplex signal on a receiving side, a phase of each antenna element of a UCA on the receiving side is only required to be reversed to a phase of an antenna element on the transmitting side.

However, in a case where interference occurs between the OAM modes due to axis misalignment between a transmitting antenna and a receiving antenna or the like, it is necessary to separate signals between the OAM modes mixed by the interference by digital signal processing such as channel equalization processing or successive interference cancellation processing. The interference between the OAM modes means that, for example, a signal transmitted from the transmission device in the OAM mode 1 is output as a signal in the OAM mode 2 on the receiving side.

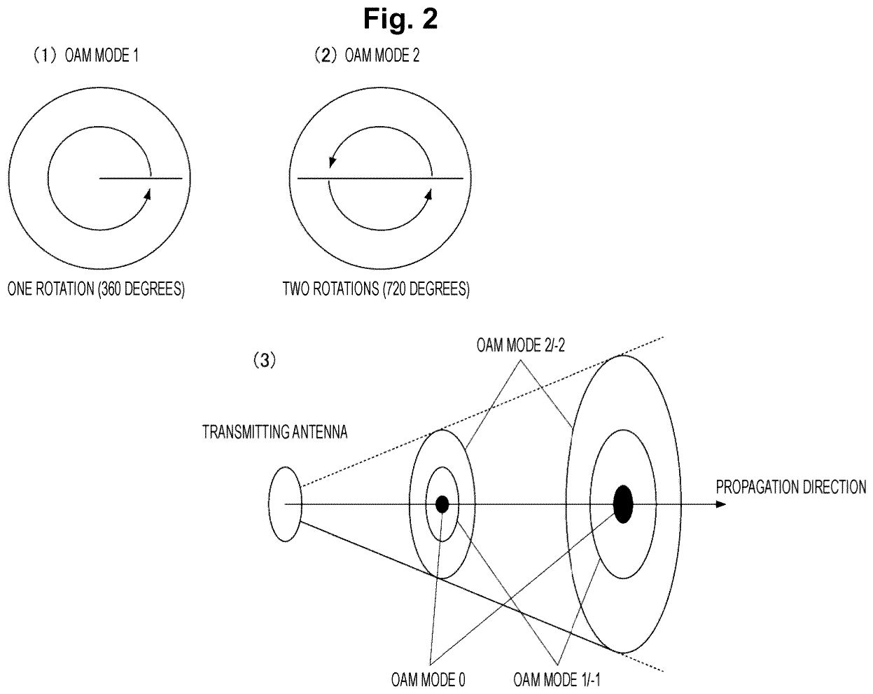

FIG. 2 is a diagram illustrating an example of a phase distribution and a signal intensity distribution of an OAM multiplex signal. In FIGS. 2 (1) and 2 (2), phase distributions of signals in the OAM mode 1 and OAM mode 2 viewed from the transmitting side at an end face (propagation orthogonal plane) orthogonal to the propagation direction are indicated by arrows. The beginning of the arrow is 0 degrees, the phase changes linearly, and the end of the arrow is 360 degrees. That is, the signal in the OAM mode n propagates while the phase rotates by n times (n×360 degrees) in the propagation orthogonal plane. The arrows of phase distributions of the signals in the OAM modes−1 and −2 are in reverse directions.

In the signal in each OAM mode, a signal intensity distribution and a position where the signal intensity is maximized are different for each OAM mode. However, the intensity distributions of the same OAM mode having different signs are the same. Specifically, as the OAM mode becomes higher, a position where the signal intensity is maximized becomes farther from the propagation axis (Non Patent Literature 2). Here, a mode having a greater value in the OAM mode will be referred to as a higher mode. For example, the signal in the OAM mode 3 is in a higher mode than the signals in the OAM mode 0, the OAM mode 1, and the OAM mode 2.

In FIG. 2 (3), a position where the signal intensity is maximized is indicated by a circular ring for each OAM mode. As the OAM mode becomes higher, the position where the signal intensity is maximized becomes farther from the central axis, a beam diameter of the OAM mode multiplex signal widens according to a propagation distance, and the circular ring indicating the position where the signal intensity is maximized widens for each OAM mode. Hereinafter, a system configuration and an operation example in the present embodiment will be described in detail.

### System Configuration of Communication System

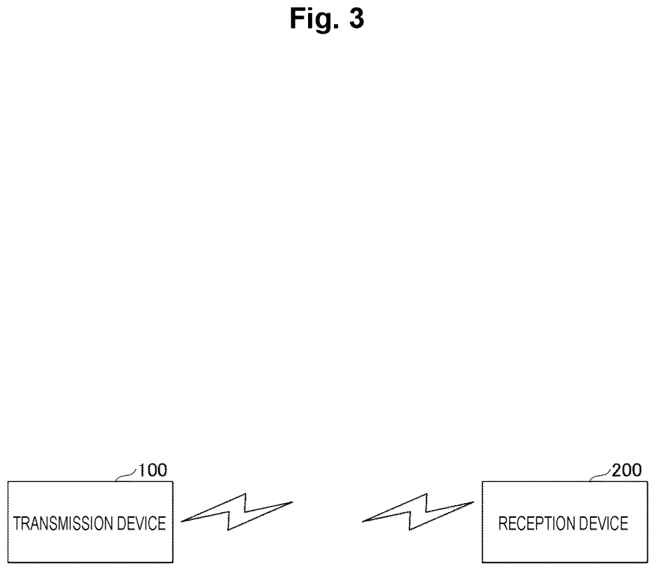

FIG. 3 is a configuration diagram illustrating a communication system in an embodiment of the present invention. As illustrated in FIG. 3, a wireless communication system in the present embodiment includes a transmission device 100 and a reception device 200.

Each of the transmission device 100 and the reception device 200 includes a UCA. In transmission and reception of the desired data, the transmission device 100 multiplexes and transmits signals in one or more OAM modes, and the reception device 200 receives the signals in which the one or more OAM modes are multiplexed and transmitted from the transmission device 100 and separates the signals in the respective OAM modes.

The transmission device 100 and the reception device 200 are wireless communication devices that perform wireless communication. In the present embodiment, it is. assumed that the transmission device 100 is a base station that does not move, and the reception device 200 is a mobile terminal. However, such an assumption is an example. For example, both the transmission device 100 and the reception device 200 may be base stations that do not move, or both the transmission device 100 and the reception device 200 may be mobile terminals. Note that, since a plurality of wireless communication devices communicate bidirectionally, each wireless communication device may also have the functions of the transmission device 100 and the reception device 200, which will be described later.

### Hardware Configuration of Transmission Device

Next, a hardware configuration of the transmission device will be described.

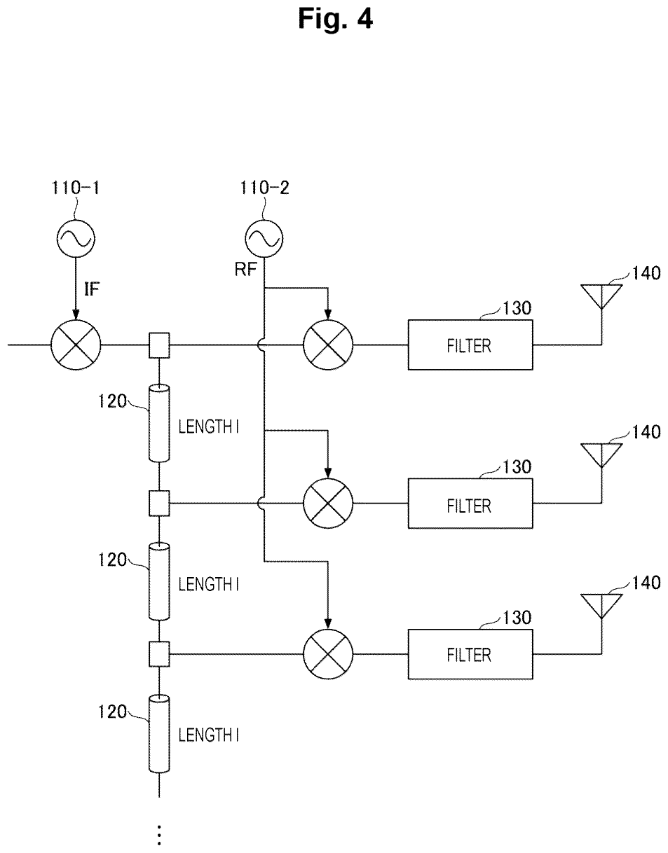

FIG. 4 is a diagram illustrating an example of a hardware configuration of the transmission device according to the embodiment of the present invention. The transmission device 100 includes a first frequency converter 110-1, a second frequency converter 110-2, one or a plurality of delay lines 120, a plurality of filters 130, and a plurality of antennas 140.

The first frequency converter 110-1 converts the frequency of the baseband signal into an intermediate frequency (IF). The delay line 120 generates a fixed time delay in the signal of the intermediate frequency. Each of the plurality of delay lines 120 may have a length 1, for example, and may be configured to continuously generate a fixed time delay in the signal of the intermediate frequency. The second frequency converter 110-2 converts the intermediate frequency into a radio frequency (RF) for transmission.

Each of the plurality of filters 130 and the plurality of antennas 140 constitutes a branch without delay and a branch delayed by a fixed time. The plurality of antennas 140 may form, for example, a circular array antenna. Accordingly, the transmission device 100 can allocate a specific OAM mode to each filter 130 and each antenna 140.

Furthermore, the transmission device 100 controls the first frequency converter 110-1 to change the intermediate frequency (IF), and controls the second frequency converter 110-2 to make the radio frequency (RF) constant regardless of the change in the intermediate frequency (IF). For example, the transmission frequency of the first frequency converter 110-1 is denoted as f1, and the transmission frequency of the second frequency converter 110-2 is denoted as f2. The transmission device 100 can transmit the signal in the OAM mode 1.0 by controlling the first frequency converter 110-1 to set f1=2 GHZ.

Here, the transmission device 100 controls the second frequency converter 110-2 to set the oscillation frequency f2 according to Equation 1, thereby making the radio frequency (RF) constant.

f2=RF−f1 (Equation 1)

Similarly, the transmission device 100 can transmit the signal in the OAM mode 1.5 by controlling the first frequency converter 110-1 to set f1=3 GHZ. Further, the transmission device 100 can transmit the signal in the OAM mode 2.0 by controlling the first frequency converter 110-1 to set f1=4 GHZ.

In this manner, the transmission device 100 can continuously switch the OAM mode of the signal to be transmitted. In addition, the transmission device 100 can implement various OAM modes such as an integer mode and a fractional mode.

With the transmission device 100 according to the present embodiment, the OAM mode can be switched with a simple configuration. For example, a plurality of serial port profiles (SPPs), a phase shift circuit, and the like are unnecessary, and a beam forming circuit and the like are also unnecessary.

### SUMMARY OF EMBODIMENT

In the present specification, at least the transmission device described in the following items is described.

### Item 1

A transmission device including:
a first frequency converter configured to convert a frequency of a baseband signal into an intermediate frequency according to a desired OAM mode;
a delay line configured to generate a delay in a signal of the intermediate frequency; and
a second frequency converter configured to convert the signal of the intermediate frequency in which the delay is generated into a constant radio frequency.

### Item 2

The transmission device according to Item 1, further including a plurality of the delay lines configured to continuously generate a fixed time delay in the signal of the intermediate frequency.

### Item 3

The transmission device according to Item 1 or 2, in which the first frequency converter is configured to convert the frequency of the baseband signal into an intermediate frequency according to an OAM mode of a fractional mode.

Any of the above configurations provides a technology capable of implementing various OAM modes. According to Item 2, a fixed time delay can be continuously generated. According to Item 3, it is possible to transmit a signal in an OAM mode of a fractional mode.

Although the present embodiment has been described, the present invention is not limited to such a specific embodiment, and various modifications and changes can be made within the scope of the gist of the present invention described in the claims.

### REFERENCE SIGNS LIST

100 Transmission device
110-1 First frequency converter
110-2 Second frequency converter
120 Delay line
130 Filter
140 Antenna
200 Reception device

1. A transmission apparatus comprising:
a first frequency converter configured to convert a frequency of a baseband signal into an intermediate frequency according to an orbital angular momentum (OAM) mode;
at least one delay line configured to generate a delay in a signal of the intermediate frequency; and
a second frequency converter configured to convert the signal of the intermediate frequency in which the delay is generated into a constant radio frequency.

2. The transmission apparatus according to claim 1, wherein the at least one delay line includes a plurality of delay lines configured to continuously generate a fixed time delay in the signal of the intermediate frequency.

3. The transmission apparatus according to claim 1, wherein the first frequency converter is configured to convert the frequency of the baseband signal into the intermediate frequency according to the OAM mode that relates to a fractional mode.
